(19) United States
(12) Patent Application Publication
(10) Pub. No.: US 2026/0347568 A1
(43) Pub. Date: Nov. 5, 2026

(54) STABLIZED COMPOSITIONS BASED ON FERTILIZERS OR PESTICIDES OR OXIDANTS

(71) Applicant: Arkema France, Puteaux (FR)

(72) Inventors: David ANDRE, PIERRE-BENITE CEDEX (FR); Gérard GUILPAIN, PIERRE-BENITE CEDEX (FR)

(21) Appl. No.: 19/488,127

(22) PCT Filed: May 30, 2024
(86) PCT No.: PCT/FR2024/050689

§ 371 Date: Nov. 26, 2025

(30) Foreign Application Priority Data
May 31, 2023 (FR) FR2305424

(51) Int. Cl. C08K 3/28; C05C 1/02; C05G 5/10; C06D 5/06

(52) U.S. Cl. CPC C08K 3/28; C05C 1/02; C05G 5/10; C06D 5/06; C08K 2003/285

(57) ABSTRACT

The present invention relates to a composition in powder form, comprising a polymer A which is a fluoropolymer A1, a polyamide A2 or a polyamide-polyether block copolymer A3, or a mixture thereof, and a compound having an oxygen balance of less than 60.

### TECHNICAL FIELD OF THE INVENTION

The present invention relates to compositions containing compounds which have heat-release or volume-expansion properties under prolonged or unsuitable storage conditions. In particular, the present invention relates to compositions containing energy-containing or oxidizing compounds, for instance fertilizers, herbicides or weed killers.

### TECHNOLOGICAL BACKGROUND OF THE INVENTION

Ammonium nitrate-based fertilizers are commonly used in the field of agriculture. While ammonium nitrate is generally a stable compound, the risk of detonation cannot be ruled out; particularly under certain storage conditions. Indeed, ammonium nitrates are classed as oxidizers. Detonation is possible in the event of contamination with combustible or incompatible substances, in the event of heating (especially under confinement, with the gases resulting from the combustion being kept confined), or in the event of a very heavy impact by an object or a shock wave.

In the past, the instability of ammonium nitrates under certain conditions has led to industrial accidents causing very severe blast effects, as happened in Toulouse or, more recently, Beirut. Solutions to stabilize ammonium nitrate-based compositions have been developed. For example, a fertilizing composition is known from the document U.S. Pat. No. 9,630,886, comprising ammonium nitrate and an effective amount of a stabilizer material to obtain a specific impulse no greater than 13.5 kPa*ms/kg when it is measured in accordance with a blast effect propagation test; wherein the stabilizer material comprises hydrocalumite, hydroxyapatite, hydrotalcite and/or apatite, wherein the stabilizer material is at least 12.5% by weight of the total fertilizing composition, wherein the stabilizer material is no greater than 35% by weight of the total fertilizer composition.

A method for producing granulated ammonium nitrate which is thermally and mechanically stable is also known from EP 1 292 537 and is characterized in that crosslinked metal silicate is dissolved in a fluid consisting essentially of nitric acid, at an amount of 1-3% by weight of the ammonium nitrate product, the solution consisting essentially of nitric acid and crosslinked metal silicate is treated with ammonia in order to form an ammonium nitrate slurry and to neutralize the solution, and the ammonium nitrate slurry is dried and granulated.

A fertilizer is also known from EP 1 981 830, comprising ammonium nitrate in the form of a double salt, and at least one stabilizing agent, wherein said at least one stabilizing agent is selected from the group consisting of MgSO₄, CaCO₃, MgCO₃, dolomite, Mg(NO₃)₂, and combinations of two or more thereof, or silicon oxide, thiourea, ammonium tartrate, ammonium oxalate, ammonium sulfate, and combinations thereof.

It is also known that ammonium nitrates tend to agglomerate or form clumps under the effect of humidity during storage, which leads to a risk of degranulation and caking of the fertilizer, which is liable to destabilize the composition. A method for preventing the agglomeration of fertilizers by adding a solution comprising polymers such as polyvinyl butyral is known, for example, from U.S. Pat. No. 3,660,070. However, it has been observed that polymers such as polyvinyl butyral exhibit unsuitable behavior under heat conditions, given the risks of detonation of ammonium nitrates.

There is still a need to provide stable fertilizing, herbicidal or weed-killing compositions which make it possible to limit the risks of detonation of compounds such as ammonium nitrates, while prevent the formation of clumps during the storage of said compounds.

### SUMMARY OF THE INVENTION

According to a first aspect, the present invention provides a composition in powder form, comprising a polymer A and a compound B comprising at least one functional group selected from the group consisting of —NO₂, NO₃⁻—ON═O, —N═N—, —N⁻═N⁺N⁻—, NX₃, where X is a halogen, —C═N—O—, ClO₃⁻, ClO₄⁻, —O—O—, —O₃— and —C≡C⁻Mt⁺, where Mt is a transition metal, characterized in that:
said polymer A is a fluoropolymer A1, a polyamide A2 or a polyamide-polyether block copolymer A3 or a mixture thereof, and
said compound B has an oxygen balance OB of less than 60, said oxygen balance being determined by the formula OB (%)=[1600*(d−2a−(b/2)]/M, where a, b and d are the number of atoms of carbon, hydrogen and oxygen, respectively, in the compound B, and M is the molar mass of said compound B.

The use of one of the polymers A as defined in the present invention makes it possible to have a versatile impact on the behavior of said compound B as defined above, in particular when the latter is subjected to rapid heating. The choice of the polymer A in said composition makes it possible to act specifically on the behavior of said compound B depending on the targeted applications, for example when the composition is intended to be implemented in a fertilizing, herbicidal, energy-containing or weed-killing formulation.

According to a preferred embodiment, said polymer A is a polyamide A2 or a polyamide-polyether block copolymer A3, or a mixture thereof. The use of polymers of the polyamide or polyamide-polyether block copolymer type prevents the release of HF in the event of a reaction during a release of heat or a deflagration.

According to a preferred embodiment, said compound B has a molar mass of less than 1000 g.mol⁻¹.

According to a preferred embodiment, said compound B is selected from the group consisting of a salt of formula M⁺X⁻, where M is selected from the group consisting of Li, Na, K and NH₄; and X is selected from the group consisting of a nitrate anion, a chlorate anion and a perchlorate anion. According to a preferred embodiment, said composition also comprises poly(vinyl butyral). According to a preferred embodiment, said polymer A is said fluoropolymer A1 comprises monomer units derived from vinylidene fluoride and optionally monomer units of a monomer selected from the group consisting of vinyl fluoride; trifluoroethylene; (VF₃); chlorotrifluoroethylene (CTFE); 1,2-difluoroethylene; tetrafluoroethylene (TFE); hexafluoropropylene (HFP); perfluoro(alkylvinyl) ethers such as perfluoro(methylvinyl) ether (PMVE), 5 perfluoro(ethylvinyl) ether (PEVE) and perfluoro(propylvinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X, where X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂, where n is 1, 2, 3, 4 or 5; the product of formula R¹CH₂OCF═CF₂, where R¹ is hydrogen or F(CF₂)m and m is 1, 2, 3 or 4; the product of formula R²OCF═CH₂, where R² is F(CF₂)p and p is 1, 2, 3 or 4; perfluorobutylethylene (PFBE); 3,3,3-trifluoropropene and 2-trifluoromethyl-3,3,3-trifluoro-1-propene, or a mixture thereof.

According to a preferred embodiment, the fluoropolymer A1 is selected from a vinylidene fluoride homopolymer or a copolymer comprising monomer units derived from vinylidene fluoride and monomer units derived from a monomer selected from the group consisting of trifluoroethylene, chlorotrifluoroethylene, 1,2-difluoroethylene, tetrafluoroethylene, hexafluoropropylene, or a mixture thereof.

According to a preferred embodiment, said fluoropolymer A1 comprises at least 50 mol % of monomer units derived from vinylidene fluoride.

According to a preferred embodiment, said polymer A3 is a polyamide-polyether block copolymer is a copolymer having amide units (Ba1) and polyether units (Ba2), said amide unit (Ba1) corresponding to an aliphatic repeating unit selected from a unit obtained from at least one amino acid, a unit obtained from at least one lactam, or a unit obtained from the polycondensation:
of at least one diamine, said diamine being preferentially selected from a linear or branched aliphatic diamine, or a mixture thereof, and
of at least one dicarboxylic acid, said diacid being preferentially selected from: a linear or branched aliphatic diacid, or a mixture thereof, said diamine and said diacid comprising from 4 to 36 carbon atoms, advantageously from 6 to 18 carbon atoms; said polyether units (Ba2) being derived in particular from at least one polyalkylene ether polyol, in particular a polyalkylene ether diol.

According to a preferred embodiment, the content by mass of polymer A in said composition is from 0.1 to 30%, preferably from 1 to 30%, in particular from 1 to 15% based on the total weight of the composition.

According to a preferred embodiment, the content by mass of said compound B in said composition is greater than 65% based on the total weight of the composition.

According to a preferred embodiment, the content by mass of said compound B in said composition is greater than 65% based on the total weight of the composition; and said polymer A is a polyamide A2 or a polyamide-polyether block copolymer A3, or a mixture thereof.

According to a preferred embodiment, the content by mass of said compound B in said composition is at least 80% based on the total weight of the composition; and said polymer A is a fluoropolymer A1.

According to a preferred embodiment, said composition consists of said polymer A and said compound B and optionally poly(vinyl butyral).

According to another aspect, the present invention relates to the use of a polymer A as a stabilizer for an energy-containing composition, in particular a weed-killing, herbicidal or fertilizing composition, said polymer A being as defined in the present invention; preferably, said polymer A is said fluoropolymer A1, and said composition preferably comprises a compound B.

According to another aspect, the present invention relates to the use of a polymer A for desensitizing or sensitizing an energy-containing composition, said polymer A being as defined in the present invention, and said composition comprising a compound B having heat-release properties or volume-expansion properties; said compound B preferably being as defined in the present invention.

According to a preferred embodiment, the content by mass of polymer A in said composition is from 0.1 to 35%, preferably from 1 to 30%, in particular from 1 to 15% based on the total weight of the composition; and the content by mass of said compound B in said composition is preferably greater than 65% based on the total weight of the composition. If the amount of polymer B in the composition is not high enough, the overall effectiveness of the composition is reduced by the effect of dilution.

According to a preferred embodiment, the content by mass of said compound B in said composition is greater than 65% based on the total weight of the composition, and said polymer A is a polyamide A2 or a polyamide-polyether block copolymer A3 or a mixture thereof; or the content by mass of said compound B in said composition is at least 80% based on the total weight of the composition; and said polymer A is a fluoropolymer A1. According to another aspect, the present invention relates to a method for decreasing or increasing the intensity of response to heat of a composition according to the present invention, said composition preferably being an energy-containing composition, said method comprising adding a polymer A as defined in the present invention to said energy-containing composition, the latter comprising a compound B having heat-release properties or volume-expansion properties; said compound B preferably being as defined in the present invention.

According to a preferred embodiment, the content by mass of polymer A in said composition is from 0.1 to 35%, preferably from 1 to 30%, in particular from 1 to 15% based on the total weight of the composition; and the content by mass of said compound B in said composition is preferably greater than 65% based on the total weight of the composition.

According to a preferred embodiment, the content by mass of said compound B in said composition is greater than 65% based on the total weight of the composition; and said polymer A is a polyamide A2 or a polyamide-polyether block copolymer A3, or a mixture thereof, or the content by mass of said compound B in said composition is at least 80% based on the total weight of the composition; and said polymer A is a fluoropolymer A1.

### BRIEF DESCRIPTION OF THE FIGURES

FIG. 1 is a graph showing the differential scanning calorimetry of different comparative compositions or compositions according to a particular embodiment of the present invention.

FIG. 2 is a graph showing the change in pressure as a function of temperature for different comparative compositions or compositions according to a particular embodiment of the present invention.

### DETAILED DESCRIPTION OF THE INVENTION

According to a first aspect of the present invention, a composition in powder form is provided. Said composition comprises a polymer A and a compound B. Said composition preferably consists of said polymer A and said compound B.

The content by mass of polymer A in said composition can be from 0.1 to 30% based on the total weight of the composition, advantageously from 0.1 to 28% based on the total weight of the composition, preferably from 0.5 to 26% based on the total weight of the composition, more preferentially from 1% to 24% based on the total weight of the composition, in particular from 1% to 22% based on the total weight of the composition, more particularly from 1% to 20% based on the total weight of the composition. According to a preferred embodiment, the content by mass of polymer A in said composition is from 0.1 to 15%, advantageously from 0.5 to 10%, preferably from 1% to 5% based on the total weight of the composition.

Preferably, the content by mass of compound B in said composition can be from 25% to 99.9% based on the total weight of the composition. According to a preferred embodiment, the content by mass of compound B in said composition is from 30% to 99.5%, advantageously from 35% to 99%, preferably from 40% to 99%, more preferentially from 50% to 95% based on the total weight of the composition. Preferably, the content by mass of compound B in said composition is greater than 65%, advantageously greater than 66%, preferably greater than 67%, more preferentially greater than 68%, in particular greater than 69%, more particularly greater than 70% based on the total weight of the composition. The content by mass of compound B in said composition can be greater than 71%, advantageously 72%, preferably greater than 73%, more preferentially greater than 74%, in particular greater than 75%, more particularly greater than 76%, favorably greater than 77%, advantageously favorably greater than 78%, preferentially favorably greater than 79%, more preferentially favorably greater than 80%, particularly favorably greater than 81%, more particularly favorably greater than 82% based on the total weight of the composition. Preferably, the content by mass of compound B in said composition can be greater than 83%, advantageously 84%, preferably greater than 85%, more preferentially greater than 86%, in particular greater than 87%, more particularly greater than 88%, favorably greater than 89%, advantageously favorably greater than 90% based on the total weight of the composition.

When said composition comprises a polyamide A2 or a polyamide-polyether block copolymer A3 or a mixture thereof as polymer A, the content by mass of said compound B in said composition is greater than 65% based on the total weight of the composition. Advantageously, when said composition comprises a polyamide A2 or a polyamide-polyether block copolymer A3 or a mixture thereof as polymer A, the content by mass of said compound B in said composition is greater than 70% based on the total weight of the composition. Preferably, when said composition comprises a polyamide A2 or a polyamide-polyether block copolymer A3 or a mixture thereof as polymer A, the content by mass of said compound B in said composition is greater than 75% based on the total weight of the composition. More preferentially, when said composition comprises a polyamide A2 or a polyamide-polyether block copolymer A3 or a mixture thereof as polymer A, the content by mass of said compound B in said composition is greater than 80% based on the total weight of the composition. In particular, when said composition comprises a polyamide A2 or a polyamide-polyether block copolymer A3 or a mixture thereof as polymer A, the content by mass of said compound B in said composition is greater than 85% based on the total weight of the composition.

More particularly, when said composition comprises a polyamide A2 or a polyamide-polyether block copolymer A3 or a mixture thereof as polymer A, the content by mass of said compound B in said composition is greater than 90% based on the total weight of the composition. According to a preferred embodiment, when said composition consists of said polymer A1 and said compound B, and optionally poly(vinyl butyral), the content by mass of compound B is one of the contents by mass above, and said polymer A and optionally poly(vinyl butyral) form the remainder, i.e. less than 35% by weight or less than 30%, or less than 25%, or less than 20%, or less than 15% by weight based on the total weight of said composition.

When said polymer A is a fluoropolymer A1, the content by mass of said compound B in said composition is at least 70% based on the total weight of the composition. Advantageously, when said polymer A is a fluoropolymer A1, the content by mass of said compound B in said composition is at least 75% based on the total weight of the composition. Preferably, when said polymer A is a fluoropolymer A1, the content by mass of said compound B in said composition is at least 80% based on the total weight of the composition. In particular, when said polymer A is a fluoropolymer A1, the content by mass of said compound B in said composition is at least 85% based on the total weight of the composition. According to a preferred embodiment, when said composition consists of said polymer A1 and said compound B, and optionally poly(vinyl butyral), the content by mass of compound B is one of the contents by mass above, and said polymer A and optionally poly(vinyl butyral) form the remainder, i.e. less than 30% by weight or less than 25%, or less than 20%, or less than 15% by weight based on the total weight of said composition.

Said composition can be prepared by adding the various constituents in powder form in the desired proportions. Alternatively, one or all of the constituents can be in solution and, after mixing them, a step of drying is carried out in order to obtain the composition in powder form.

Depending on the nature of the compound B present in said composition, said composition can be a weed-killing, fertilizing or herbicidal composition, or more generally an energy-containing composition. “Energy-containing composition” means a composition in which the compound B is an energy-containing substance, usually in the form of a solid crystalline powder, which may have heat-release or thermal expansion properties depending on the conditions to which the compound is subjected. Such substances having an energy load are in particular present in compositions which can be used in fertilizers, weed killers, demolition, welding, or are for example gas-generating substances or pyrotechnic substances.

In addition, said composition can comprise other constituents such as anti-caking agents, anti-foaming agents, hydrophobic agents or corrosion inhibitors. According to a particular embodiment, said composition in particular comprises polyvinyl butyral, polyvinyl acetate, polybutadiene, polyurethane, thermoplastic elastomers or polysulfides or a mixture thereof.

### Polymer A

As mentioned above, said composition comprises a polymer A. The latter can be a fluoropolymer A1, a polyamide A2 or a polyamide-polyether block copolymer A3 or a mixture thereof.

### Fluoropolymer A1

According to a preferred embodiment, said fluoropolymer A1 comprises monomer units derived from a monomer selected from the group consisting of vinylidene fluoride, vinyl fluoride; trifluoroethylene; (VF₃); chlorotrifluoroethylene (CTFE); 1,2-difluoroethylene; tetrafluoroethylene (TFE); hexafluoropropylene (HFP); perfluoro(alkylvinyl) ethers such as perfluoro(methylvinyl) ether (PMVE), perfluoro(ethylvinyl) ether (PEVE) and perfluoro(propylvinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X, where X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂, where n is 1, 2, 3, 4 or 5; the product of formula R¹CH₂OCF═CF₂, where R¹ is hydrogen or F(CF₂)m and m is 1, 2, 3 or 4; the product of formula R²OCF═CH₂, where R² is F(CF₂)p and p is 1, 2, 3 or 4; perfluorobutylethylene (PFBE); 3,3,3-trifluoropropene and 2-trifluoromethyl-3,3,3-trifluoro-1-propene, or a mixture thereof.

According to one embodiment, said fluoropolymer A1 is a vinylidene fluoride homopolymer.

According to another embodiment, said fluoropolymer A1 is a copolymer of vinylidene fluoride with at least one comonomer compatible with vinylidene fluoride. The comonomers compatible with vinylidene fluoride can be halogenated (fluorinated, chlorinated or brominated) or non-halogenated. Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf-O-CF-CF₂, Rf being an alkyl group, preferably a C₁ to C₄ alkyl group (preferred examples being perfluoro(propyl vinyl ether) and perfluoro(methyl vinyl ether)). The fluorinated comonomer can include a chlorine or bromine atom. It can in particular be selected from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably 1-chloro-3,3,3-trifluoropropene or 2-chloro-3,3,3-trifluoropropene. The VDF copolymer can also comprise non-halogenated monomers, such as ethylene, and/or acrylic or methacrylic comonomers.

The fluoropolymer A1 preferably contains at least 50 mol % of vinylidene fluoride, advantageously at least 60 mol % of vinylidene fluoride, preferably at least 70 mol % of vinylidene fluoride. The comonomer can be present in a content of from 1 to 50%, advantageously from 2 to 30% by weight relative to the weight of said fluoropolymer A1.

According to one embodiment, the fluoropolymer A1 is a copolymer of vinylidene fluoride (VDF) and hexafluoropropylene (HFP) (P(VDF-HFP)), having a percentage by weight of hexafluoropropylene monomer units of from 2 to 30%, advantageously from 2 to 25%, preferably from 2 to 20%, preferably from 4 to 15% by weight relative to the weight of said fluoropolymer A1. According to another embodiment, the fluoropolymer A1 is a copolymer of vinylidene fluoride (VDF) and hexafluoropropylene (HFP) (P(VDF-HFP)), having a percentage by weight of hexafluoropropylene monomer units of from 10 to 30%, advantageously from 10 to 25% by weight relative to the weight of said fluoropolymer A1.

According to another preferred embodiment, the fluoropolymer A1 is a copolymer of vinylidene fluoride and tetrafluoroethylene (TFE).

According to another embodiment, the fluoropolymer A1 is a copolymer of vinylidene fluoride and chlorotrifluoroethylene (CTFE), containing at least 50 mol % of vinylidene fluoride, advantageously at least 60 mol % of vinylidene fluoride, preferably at least 70 mol % of vinylidene fluoride.

According to another embodiment, the fluoropolymer A1 is a VDF-TFE-HFP terpolymer. According to one embodiment, the fluoropolymer A1 is a VDF-TrFE-TFE terpolymer (TrFE being trifluoroethylene). In these terpolymers, the content by mass of VDF is at least 10%, the comonomers being present in variable proportions.

According to one embodiment, the fluoropolymer A1 comprises monomer units bearing at least one of the following functions: carboxylic acid, carboxylic acid anhydride, carboxylic acid esters, or epoxy (such as glycidyl), amide, hydroxyl, carbonyl, mercapto, sulfide, oxazoline, phenolic, ester, ether, siloxane, sulfonic, sulfuric, phosphoric or phosphonic groups. The function is introduced by a chemical reaction which can be grafting or a copolymerization of the vinylidene fluoride (VDF) monomer with a monomer bearing at least one of said functional groups and a vinyl function capable of copolymerizing with the VDF monomer, according to techniques well known to those skilled in the art.

According to one embodiment, the functional group bears a carboxylic acid function which is a group of (meth)acrylic acid type, selected from acrylic acid, methacrylic acid, hydroxyethyl (meth)acrylate, hydroxypropyl (meth)acrylate and hydroxyethylhexyl (meth)acrylate. Thus, said fluoropolymer A1 can comprise monomer units derived from a monomer selected from the group consisting of acrylic acid, methacrylic acid, methyl acrylate, methyl methacrylate, hydroxyethyl methacrylate, hydroxypropyl methacrylate and hydroxyethylhexyl methacrylate.

According to one embodiment, the units bearing the carboxylic acid function additionally comprise a heteroatom selected from oxygen, sulfur, nitrogen and phosphorus.

According to a preferred embodiment, said fluoropolymer A1 can, for example, be a copolymer of vinylidene fluoride and a monomer M1′ selected from the group consisting of acrylic acid, methacrylic acid, hydroxyethyl (meth)acrylate, hydroxypropyl (meth)acrylate, hydroxyethylhexyl (meth)acrylate and acryloyloxypropyl succinate. Preferably, the content of monomer M1′ in said fluoropolymer A1 is from 0.01 mol % to 5 mol %. In this embodiment, at least 40% of the units derived from the monomer M1′ are distributed between two vinylidene fluoride units.

The content of functional groups of said fluoropolymer A1 is at least 0.01 mol %, preferably at least 0.1 mol %, and at most 15 mol %, preferably at most 10 mol %.

The fluoropolymer A1 preferably has a high molecular weight. “High molecular weight”, as used here, means a fluoropolymer A1 having a melt viscosity of greater than 100 Pa·s, preferably of greater than 500 Pa·s, more preferably of greater than 1000 Pa·s, according to the ASTM D-3835 method, measured at 232 °C and 100 sec⁻¹.

According to one embodiment, said fluoropolymer A1 bearing functional groups can undergo crosslinking either by self-condensation of its functional groups or by reaction with a catalyst and/or a crosslinking agent, such as melamine resins, epoxy resins and the like, and also known crosslinking agents of low molecular weight, such as di- or higher polyisocyanates, polyaziridines, polycarbodiimides, polyoxazolines, dialdehydes such as glyoxal, acetoacetates, malonates, acetals, thiols and acrylates which are di-and trifunctional, cycloaliphatic epoxy molecules, organosilanes, such as epoxysilanes and aminosilanes, carbamates, diamines and triamines, inorganic chelating agents, such as certain zinc and zirconium salts, titaniums, glycourils and other aminoplasts. In certain cases, functional groups originating from other polymerization ingredients, such as surfactants, initiators or seed particles, can be involved in the crosslinking reaction. When two or more functional groups are involved in the crosslinking process, the pairs of complementary reactive groups are, for example, hydroxyl-isocyanate, acid-epoxy, amine-epoxy, hydroxyl-melamine, acetoacetate-acid. The acrylate and/or methacrylate monomers not containing functional groups capable of participating in crosslinking reactions after the polymerization should preferably represent 70% or more by weight of the total mixture of monomers and more preferably should be greater than 90% by weight. According to one embodiment, the fluoropolymer A1 comprises a crosslinking agent selected from the group consisting of isocyanates, diamines, adipic acid, dihydrazides and combinations thereof.

According to another embodiment, said fluoropolymer A1 can be in a mixture with a hydrophilic polymer A1″. Said polymer A1″ comprises monomer units derived from a monomer M1″ of formula R¹R²C═C(R³)C(O)R in which the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five-or ten-membered heterocycle comprising at least one nitrogen atom in its cyclic chain. Said heterocycle can be saturated or unsaturated or aromatic. Said heterocycle can be monocyclic or bicyclic. Said heterocycle can be a pyrrole, pyrrolidine, pyridine, piperidine, pyrimidine, pyrazine, 1,4-dihydropyridine, indole, oxindole, isatin, quinoline, isoquinoline, quinazoline, imidazoline, pyrazolidine, 2-pyrrolidone, 8-lactam, succinimide, 2-imidazolidinone or 4-imidazolidinone ring. Said heterocycle can be substituted with one or more C₁-C₅ alkyl groups. As mentioned above, the C₁-C₁₈ alkyl is optionally substituted with said heterocycle. The latter can be bonded to the alkyl chain via the nitrogen atom or any other atom forming the heterocycle. Preferably, the heterocycle is 2-pyrrolidone, 8-lactam, succinimide, 2-imidazolidinone or 4-imidazolidinone.

Preferably, said polymer A1″ comprises monomer units derived from an alkyl (meth)acrylate monomer M1″ of formula R¹R²C═C(R³)C(O)R in which the substituents R¹, R² and R³ are selected, independently of one another, from the group consisting of H and C1-C5 alkyl; R is selected from the group consisting of —NHC(CH₃)₂CH₂C(O)CH₃ or —OR′ with R′ selected from the group consisting of C₁-C₁₈ alkyl optionally substituted with one or more —OH group(s) or a five- or ten-membered heterocycle comprising at least one nitrogen atom in its cyclic chain. Preferably, the heterocycle is as defined above; in particular, the heterocycle is 2-pyrrolidone, 8-lactam, succinimide, 2-imidazolidinone or 4-imidazolidinone. The term “alkyl (meth)acrylate” encompasses alkyl acrylates and alkyl methacrylates. According to a preferred embodiment, the substituent R′ is selected from the group consisting of H, methyl, ethyl, propyl, n-butyl, isobutyl, t-butyl, n-dodecyl, amyl, isoamyl, hexyl, 2-ethylhexyl, lauryl, n-octyl, hydroxybutyl, hydroxypropyl and ethyl, substituted with a ureido, hydroxyethyl, hydroxypropyl or hydroxybutyl group.

In particular, said polymer P1″ comprises monomer units derived from an alkyl (meth)acrylate monomer M1″ of formula R¹R²C═C(R³)C(O)R in which the substituents R¹ and R² are H; R³ is H or CH₃; R is —OR′ with R′ selected from the group consisting of H, methyl, ethyl, propyl, n-butyl, isobutyl, t-butyl, hydroxypropyl, hydroxybutyl, 2-pyrrolidone, 8-lactam, succinimide, 2-imidazolidinone or 4-imidazolidinone.

Thus, the alkyl (meth)acrylate can be methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and the mixtures thereof. Among these, the alkyl acrylates with an alkyl group having from 1 to 8 carbon atoms are preferred, and the alkyl acrylates with an alkyl group having from 1 to 5 carbon atoms are more preferable. These compounds can be used alone or as a mixture of two or more. Thus, said polymer P1″ may be a homopolymer of a monomer M1″ as defined above or a copolymer derived from a mixture of one or more monomers M1″ as defined above.

The term “acrylate” here covers acrylates and methacrylates.

Said monomer M1″ can be copolymerized with an ethylenically unsaturated compound which can copolymerize with alkyl acrylate and alkyl methacrylate, such as:
(A) an alkenyl compound containing a functional group, and
(B) an alkenyl compound without a functional group.

The alkenyl compound (A) containing a functional group comprises, for example, α,β-unsaturated carboxylic acids such as acrylic acid, methacrylic acid, fumaric acid, crotonic acid, itaconic acid and the like; vinyl ester compounds such as vinyl acetate, vinyl neodecanoate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N, N-dialkylacrylamide, N, N-dialkylmethacrylamide, diacetone acrylamide and the like; acrylic acid esters such as 2-hydroxyethyl acrylate, N-dialkylaminoethyl acrylate, glycidyl acrylate, n-dodecyl acrylate, fluoroalkyl acrylate and the like; and methacrylic acid esters such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds can be used alone or as a mixture of two or more.

The alkenyl compound without a functional group (B) comprises, for example, conjugated dienes, such as 1,3-butadiene, isoprene and the like; divinyl hydrocarbon compounds, such as divinylbenzene and the like; and alkenyl cyanides, such as acrylonitrile, methacrylonitrile and the like. Among these, the preferred compounds are 1,3-butadiene and acrylonitrile. These compounds can be used alone or as a mixture of two or more.

It is preferable for the functional alkenyl compound (A) to be used in a proportion of less than 50% by weight, relative to the weight of the mixture of monomers, and for the alkenyl compound without a functional group (B) to be used in a proportion of less than 30% by weight, relative to the weight of the mixture of monomers.

According to certain embodiments, the polymers A1 and A1″ are biobased compounds. The term “biobased” means “resulting from biomass”. This makes it possible to improve the ecological footprint of the composition. Biobased vinylidene fluoride can be characterized by a content of renewable carbon, that is to say of carbon of natural origin originating from a biomaterial or from biomass, of at least 1 atom %, as determined by the content of 14C according to Standard NF EN 16640. The term “renewable carbon” indicates that the carbon is of natural origin and originates from a biomaterial (or from biomass), as indicated below. According to certain embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

The homopolymers and the copolymers of vinylidene fluoride used in the invention can be obtained by known polymerization methods, such as emulsion or suspension polymerization. According to one embodiment, they are prepared by an emulsion polymerization process in the absence of a fluorinated surfactant.

The polymerization of the vinylidene fluoride preferably results in a latex generally having a solids content of from 10 to 60% by weight, preferably from 10 to 50%, and having a weight-average particle size of less than 1 micrometre, preferably less than 1000 nm, preferably less than 800 nm and more preferably less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometers and preferably from 2 to 20 micrometers. The agglomerates can break up into discrete particles during formulation and application to a substrate.

When said fluoropolymer A1 is in a mixture with said polymer P1″, the content by weight of polymer A1 is at least 50%, advantageously at least 60%, preferably at least 70%, more preferentially at least 80%, in particular at least 90%, based on the total weight of said polymers A1 and P1″ in said composition.

### Polyamide A2

The term “polyamide” using the present description covers both homopolyamides and copolyamides. Preferably, said polyamide A2 is a semicrystalline aliphatic polyamide. Said polyamide A2 can be obtained from the polycondensation of at least one lactam, or from the polycondensation of at least one amino acid, or from the polycondensation of at least one diamine X with at least one dicarboxylic acid Y.

When said polyamide A2 is obtained from the polycondensation of at least one lactam, it can then comprise a single lactam or several lactams.

When said polyamide A2 is obtained from the polycondensation of at least one lactam, said at least one lactam is selected from a C6 to C18 lactam, preferentially a C8 to C12 lactam, more preferentially a C10 to C12 lactam.

Advantageously, said polyamide A2 is obtained from the polycondensation of a single lactam and said lactam can be is in particular selected from caprolactam, lauryllactam and undecanolactam, advantageously lauryllactam.

When said polyamide A2 is obtained from the polycondensation of at least one amino acid, said at least one amino acid can be selected from a C6 to C18 amino acid, preferentially a C10 to C18 amino acid, more preferentially a C10 to C12 amino acid.

A C6 to C12 amino acid is in particluar 6-aminohexanoic acid, 9-aminononanoic acid, 10-aminodecanoic acid, 10-aminoundecanoic acid, 12-aminododecanoic acid and 11-aminoundecanoic acid and also derivatives thereof, in particular N-heptyl-11-aminoundecanoic acid.

When said polyamide A2 is obtained from the polycondensation of at least one amino acid, it can then comprise a single amino acid or several amino acids.

Advantageously, said polyamide A2 is obtained from the polycondensation of a single amino acid and said amino acid is selected from 11-aminoundecanoic acid and 12-aminododecanoic acid, advantageously 11-aminoundecanoic acid.

When said polyamide A2 is obtained from the polycondensation of at least one diamine X with at least one diacid Y, then the diamine is C4-C36, preferentially C6-C18, preferentially C6-C12, more preferentially C10-C12, with at least one diacid Y being C4-C36, preferentially C6-C18, preferentially C6-C12, more preferentially C8-C12, and said at least one diamine X is an aliphatic diamine and said at least one diacid Y is an aliphatic diacid.

The diamine can be linear or branched. Advantageously, it is linear.

Said at least one C4-C36 diamine X may be selected in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is a C6-C18 diamine and is selected from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is selected in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular selected from 1,10-decamethylenediamine, 1,11-undecamethylenediamine and 1,12-dodecamethylenediamine.

Said at least one dicarboxylic acid Y is a C4 to C36 dicarboxylic acid and can be selected from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, heptadecanedioic acid, octadecanedioic acid and diacids obtained from fatty acids.

The diacid can be linear or branched. Advantageously, it is linear.

Advantageously, said at least one dicarboxylic acid Y is a C6-C18 dicarboxylic acid and is selected from adipic acid, suberic acid, azelaic acid, sebacic acid, undecanedioic acid, dodecanedioic acid, brassylic acid, tetradecanedioic acid, pentadecanedioic acid, hexadecanedioic acid, heptadecanedioic acid and octadecanedioic acid.

Advantageously, said at least one dicarboxylic acid Y is a C6 to C12 dicarboxylic acid and is selected from adipic acid, suberic acid, azelaic acid, sebacic acid, undecanedioic acid and dodecanedioic acid. Advantageously, the mean number of carbon atoms with respect to the nitrogen atom of the semicrystalline aliphatic polyamide is greater than or equal to 6.

Advantageously, said at least one dicarboxylic acid Y is a C8-C12 dicarboxylic acid and is selected from suberic acid, azelaic acid, sebacic acid, undecanedioic acid and dodecanedioic acid.

Advantageously, said at least one semicrystalline aliphatic polyamide is obtained from the polycondensation of at least one C7 to C18 amino acid, preferentially C7 to C12, more preferentially C10 to C12, or at least one C7 to C18 lactam, preferentially C7 to C12, more preferentially C10 to C12.

More advantageously, the mean number of carbon atoms with respect to the nitrogen atom of the semicrystalline aliphatic polyamide is greater than or equal to 8.

In particular, the mean number of carbon atoms with respect to the nitrogen atom of the semicrystalline aliphatic polyamide is from 8 to 14.

Advantageously, said polyamide A2 is selected from PA510, PA512, PA514, PA610, PA612, PA1010, PA1012, PA1212, PA11 and PA 12, in particular PA1010, PA1012, PA1212, PA11 and PA 12.

Even more advantageously, the mean number of carbon atoms with respect to the nitrogen atom of the semicrystalline aliphatic polyamide is greater than or equal to 9.

In particular, the mean number of carbon atoms with respect to the nitrogen atom of the semicrystalline aliphatic polyamide is from 9 to 14.

More advantageously, the mean number of carbon atoms with respect to the nitrogen atom of the semicrystalline aliphatic polyamide is greater than or equal to 10.

In particular, the mean number of carbon atoms with respect to the nitrogen atom of the semicrystalline aliphatic polyamide is from 10 to 14.

Advantageously, said semicrystalline polyamide is chosen from PA11 and PA12, more particularly PA11.

In the case of a homopolyamide of PA-XY type, the number of carbon atoms per nitrogen atom is the mean of the unit X and of the unit Y.

In the case of a copolyamide, the number of carbons per nitrogen atom is calculated according to the same principle. The calculation is performed on a molar pro rata basis for the different amide units.

When said polyamide A2 is obtained from the polycondensation of at least one diamine X with at least one dicarboxylic acid Y, it can therefore comprise a single diamine or several diamines and a single dicarboxylic acid or several dicarboxylic acids.

In one embodiment, said polyamide A2 is obtained from the polycondensation of a single diamine X with a single dicarboxylic acid Y.

Advantageously, the semicrystalline aliphatic polyamide is selected from PA10, PA11, PA12, PA1010 and PA1012, in particular PA11 and PA12.

Advantageously, the semicrystalline polyamide is partially or totally biobased.

### Polyamide-Polyether Block Copolymers A3

The polyamide-polyether block copolymers are copolymers containing amide units (Ba1) and polyether units (Ba2), said amide unit (Ba1) corresponding to an aliphatic repeating unit selected from a unit obtained from at least one amino acid, a unit obtained from at least one lactam, or a unit obtained from the polycondensation:
of at least one diamine, said diamine being preferentially selected from a linear or branched aliphatic diamine, or a mixture thereof, and
of at least one dicarboxylic acid, said diacid being preferentially selected from:

a linear or branched aliphatic diacid, or a mixture thereof, said diamine and said diacid comprising from 4 to 36 carbon atoms, advantageously from 6 to 18 carbon atoms; said polyether units (Ba2) being derived in particular from at least one polyalkylene ether polyol, in particular a polyalkylene ether diol.

The copolymers A3 result in particular from the copolycondensation of polyamide blocks having reactive ends with polyether blocks having reactive ends, such as:
1) polyamide blocks bearing diamine chain ends with polyoxyalkylene blocks bearing dicarboxylic chain ends.
2) Polyamide blocks bearing dicarboxylic chain ends with polyoxyalkylene blocks bearing diamine chain ends, obtained by cyanoethylation and hydrogenation of aliphatic a, w-dihydroxylated polyoxyalkylene blocks referred to as polyalkylene ether diols (polyether diols).
3) Polyamide blocks bearing dicarboxylic chain ends with polyether diols, the products obtained being, in this particular case, polyetheresteramides. The copolymers of the invention are advantageously of this type.

The polyamide blocks bearing dicarboxylic chain ends originate, for example, from the condensation of polyamide precursors in the presence of a chain-limiting dicarboxylic acid.

The polyamide blocks bearing diamine chain ends originate, for example, from the condensation of polyamide precursors in the presence of a chain-limiting diamine.

The copolymers bearing polyamide blocks and polyether blocks can also comprise randomly distributed units. These polymers can be prepared by the simultaneous reaction of the polyether and of the precursors of the polyamide blocks.

For example, it is possible to react polyether diol, polyamide precursors and a chain-limiting diacid. A polymer is obtained essentially having polyether blocks and polyamide blocks of very variable length, but also the various reagents that have reacted randomly, which are distributed randomly (statistically) along the polymer chain.

It is also possible to react polyetherdiamine, polyamide precursors and a chain-limiting diacid. A polymer is obtained essentially having polyether blocks and polyamide blocks of very variable length, but also the various reagents that have reacted randomly, which are distributed randomly (statistically) along the polymer chain.

Amide unit (Ba1): The amide unit (Ba1) corresponds to an aliphatic repeating unit as defined above. Advantageously, the amide unit (Ba1) is selected from polyamide 11, polyamide 12, polyamide 610, polyamide 612, polyamide 1010, polyamide 1012, in particular polyamide 11. More advantageously, the amide unit (Ba1) is selected from polyamide 11 and polyamide 12.

### Polyether Unit (Ba2)

The polyether units are in particular derived from at least one polyalkylene ether polyol; in particular, they are derived from at least one polyalkylene ether polyol; in other words, the polyether units consist of at least one polyalkylene ether polyol. In this embodiment, the term “at least one polyalkylene ether polyol” means that the polyether units consist of alcohol chain ends and thus cannot be a compound of the polyetherdiamine triblock type. Advantageously, the polyether units (Ba2) are selected from polyethylene glycol (PEG), polypropylene glycol (PPG), polytrimethylene glycol (PO3G), polytetramethylene glycol (PTMG) and mixtures thereof or copolymers thereof, in particular PTMG. The number-average molecular mass (Mn) of the polyether blocks is advantageously from 200 to 4000 g/mol, preferably from 250 to 2500 g/mol, in particluar from 300 to 1100 g/mol.

The copolymer A3 can be prepared by the following method, according to which:
in a first step, the polyamide blocks (Ba1) are prepared by polycondensation of the lactam(s), or
of the amino acid(s), or
of the diamine(s) and of the dicarboxylic acid(s); and where appropriate, of the comonomer(s) selected from lactams and α,ω-aminocarboxylic acids;
in the presence of a chain limiter selected from dicarboxylic acids; and then
in a second step, the polyamide blocks (Ba1) obtained are reacted with the polyether blocks (Ba2), in the presence of a catalyst.

The two-step general method of preparation for the copolymers of the invention is known and is described for example in French patent FR 2 846 332 and European patent EP 1 482 011. The reaction for forming block (Ba1) is usually performed between 180 and 300 °C, preferably from 200 to 290 °C, and the pressure in the reactor becomes established at between 5 and 30 bar and is maintained for about 2 to 3 hours. The pressure is reduced slowly while returning the reactor to atmospheric pressure and the excess water is then distilled off, for example over one or two hours. Once the polyamide bearing carboxylic acid end groups has been prepared, the polyether and a catalyst are then added. The polyether can be added in one or more portions, as can the catalyst. According to an advantageous form, the polyether is first added; the reaction of the OH end groups of the polyether and of the COOH end groups of the polyamide begins with the formation of ester bonds and the elimination of water. As much water as possible is removed from the reaction medium by distillation, then the catalyst is introduced to complete the linking of the polyamide blocks and the polyether blocks. This second step is performed with stirring, preferably under a vacuum of at least 15 mmHg (2000 Pa), at a temperature such that the reagents and the copolymers obtained are in molten form. For example, this temperature may be between 100 and 400 °C and more commonly between 200 and 300 °C. The reaction is monitored by measuring the torque exerted by the molten polymer on the stirrer or by measuring the electrical power consumed by the stirrer. The end of the reaction is determined by the target torque or power value. It is also possible to add, during synthesis, at the moment deemed to be the most opportune, one or more molecules used as antioxidant, for example Irganox® 1010 or Irganox® 245.

It is also possible to consider the method for preparing the copolymer A3 such that all the monomers are added at the start, i.e. in a single step, to bring about the polycondensation:
of the lactam(s), or
of the amino acid(s), or
of the diamine(s) and of the dicarboxylic acid(s); and, where appropriate, of the other polyamide comonomer(s);
in the presence of a chain limiter selected from dicarboxylic acids;
in the presence of the (Ba2) (polyether) blocks;
in the presence of a catalyst for the reaction between the flexible (Ba2) blocks and the (Ba1) blocks. Advantageously, said dicarboxylic acid is used as chain limiter and is introduced in excess relative to the stoichiometry of the diamine(s).

Advantageously, a derivative of a metal selected from the group formed of titanium, zirconium and hafnium, or a strong acid such as phosphoric acid, hypophosphorous acid or boric acid, is used as catalyst.

The polycondensation can be performed at a temperature from 240 to 280 °C.

Generally speaking, the known copolymers bearing ether and amide units consist of semicrystalline linear, aliphatic polyamide blocks. In one embodiment, the copolymer A3 has a flexural modulus of less than 200 MPa, in particular less than 100 MPa, as measured according to standard ISO 178 :2010 at 23 °C. In another embodiment, the copolymer A3 has a density of greater than or equal to 1, as determined according to ISO 1183-3: 1999.

### Compound B

As mentioned above, said composition comprises a compound B.

According to a preferred embodiment, said compound B has an oxygen balance OB of less than 60, said oxygen balance being determined by the formula OB (%)=[1600*(d−2a−(b/2)]/M, where a, b and d are the number of atoms of carbon, hydrogen and oxygen, respectively, in the compound B, and M is the molar mass of said compound B.

The oxygen balance, expressed as a percentage by mass, represents the concentration of oxygen contained in said compound B. It is defined as the oxygen content available after oxidation of the hydrogen, carbon and metals which may be present for producing water, carbon dioxide and optionally metal oxides. If the value of the oxygen balance is positive, the compound B is an oxidant and is therefore rich in oxygen. Conversely, a negative oxygen balance indicates a low amount of oxygen is present. When there is enough oxygen to exclusively produce CO₂ and H₂O and metal oxides without excess, the oxygen balance is zero.

Advantageously, said oxygen balance of said compound B is less than 58%, preferably less than 56%, more preferentially less than 54%, in particular less than 52%, more particularly less than 50%. According to a preferred embodiment, said oxygen balance of said compound B is greater than −260%, advantageously greater than −225%, preferably greater than −200%, more preferentially greater than −175%, in particular greater than −150%, more particularly greater than −125%, favorably greater than −100%.

Thus, said oxygen balance of said compound B can be less than 60%, advantageously less than 58%, preferably less than 56%, more preferentially less than 54%, in particular less than 52%, more particularly less than 50%; and greater than −260%, advantageously greater than −225%, preferably greater than −200%, more preferentially greater than −175%, in particular greater than −150%, more particularly greater than −125%, favorably greater than −100%.

According to a preferred embodiment, said compound B comprises at least one functional group selected from the group consisting of —NO₂, NO₃⁻—ON═O, —N═N—, —N═N⁺N⁻—, NX₃, where X is a halogen, —C═N—O—, ClO₃⁻, ClO₄⁻, —O—O—, —O₃— and —C≡C⁻Mt⁺, where Mt is a transition metal. Said transition metal can be a metal from columns 3 to 11 of the Periodic Table of the Elements. Preferably, said compound B comprises at least one functional group selected from the group consisting of —NO₂, NO₃⁻, —ON═O, —N═N—, —N⁻═N⁺N⁻—, ClO₃⁻, ClO₄⁻, —O—O— and —O₃—.

According to a particularly preferred embodiment, said compound B has an oxygen balance of less than 60%, advantageously less than 58%, preferably less than 56%, more preferentially less than 54%, in particular less than 52%, more particularly less than 50%; and said compound comprises at least one functional group selected from the group consisting of —NO₂, NO₃⁻, —ON═O, —N═N—, —N⁻═N⁺N⁻—, NX₃, where X is a halogen, —C═N—O—, ClO₃⁻, ClO₄⁻, —O—O—, —O₃— and —C≡C⁻Mt⁺, where Mt is a transition metal. Preferably, said compound B has an oxygen balance of less than 60%, advantageously less than 58%, preferably less than 56%, more preferentially less than 54%, in particular less than 52%, more particularly less than 50%; and said compound comprises at least one functional group selected from the group consisting of —NO2, NO₃⁻, —ON═O, —N═N—, —N⁻═N⁺N⁻—, ClO₃⁻, ClO₄⁻, —O—O— and —O₃—.

According to a more particularly preferred embodiment, said compound B has an oxygen balance of less than 60%, advantageously less than 58%, preferably less than 56%, more preferentially less than 54%, in particular less than 52%, more particularly less than 50%; and of greater than −260%, advantageously greater than −225%, preferably greater than −200%, more preferentially greater than −175%, in particular greater than −150%, more particularly greater than −125%, favorably greater than −100%; and said compound comprises at least one functional group selected from the group consisting of —NO₂, NO₃⁻, —ON═O, —N═N—, —N⁻═N⁺N⁻—, NX₃, where X is a halogen, —C═N—O—, ClO₃⁻, ClO₄⁻, —O—O—, —O₃— and —C≡C⁻Mt⁺, where Mt is a transition metal. Preferably, said compound B has an oxygen balance of less than 60%, advantageously less than 58%, preferably less than 56%, more preferentially less than 54%, in particular less than 52%, more particularly less than 50%; and of greater than −260%, advantageously greater than −225%, preferably greater than −200%, more preferentially greater than −175%, in particular greater than −150%, more particularly greater than 125%, favorably greater than −100%; and said compound comprises at least one functional group selected from the group consisting of —NO₂, NO₃⁻, —ON═O, —N═N—, —N⁻═N⁺N⁻—, ClO₃⁻, ClO₄⁻, —O—O— and —O₃⁻.

As mentioned above, said compound B can preferably be a fertilizing, pesticidal, or oxidizing compound, or more generally an energy-containing compound. Thus, in a preferred embodiment, said compound B is selected from the group consisting of a salt of formula M⁺X⁻, where M is selected from the group consisting of Li, Na, K and NH₄; and X is selected from the group consisting of a nitrate anion, a chlorate anion and a perchlorate anion. Said compound B can be ammonium nitrate, potassium nitrate, potassium chlorate, sodium chlorate, sodium perchlorate, potassium perchlorate, ammonium chlorate or ammonium perchlorate.

As mentioned in the present application, said polymer A according to the present invention can be used in various fields.

According to a preferred embodiment, said polymer A is used as a stabilizer in an energy-containing composition. Preferably, said polymer A is used as a stabilizer in a weed-killing, herbicidal or fertilizing composition. In this case, said polymer A is as defined in the present invention, and said polymer A is preferably said fluoropolymer A1 or a polyamide A2 or a polyamide-polyether block copolymer A3 or a mixture thereof.

According to another embodiment, the present invention relates to the use of a polymer A for desensitizing or sensitizing an energy-containing composition, said polymer A being as defined in the present invention, and said energy-containing composition comprising a compound B having heat-release properties or volume-expansion properties; said compound B preferably being as defined in the present invention. Preferably, said polymer A1 is used for desensitizing an energy-containing composition comprising a compound B having heat-release properties or volume-expansion properties; said compound B preferably being as defined in the present invention. Alternatively, said polyamide-polyether block copolymer A3 or said polyamide A2 is used for sensitizing an energy-containing composition comprising a compound B having heat-release properties or volume-expansion properties; said compound B preferably being as defined in the present invention.

According to another embodiment, the present invention relates to a method for decreasing or increasing the intensity of response to heat of an energy-containing composition, said method comprising adding a polymer A as defined in the present invention to said composition, the latter comprising a compound B having heat-release properties or volume-expansion properties; said compound B preferably being as defined in the present invention. Preferably, said method is a method for decreasing the intensity of response to heat of an energy-containing composition, said method comprising adding a polymer A1 as defined in the present invention to said composition, the latter comprising a compound B having heat-release properties or volume-expansion properties; said compound B preferably being as defined in the present invention. Alternatively, said method is a method for increasing the intensity of response to heat of an energy-containing composition, said method comprising adding said polyamide-polyether block copolymer A3 or said polyamide A2 as defined in the present invention to said composition, the latter comprising a compound B having heat-release properties or volume-expansion properties; said compound B preferably being as defined in the present invention.

### DSC Measurement

The prepared mixtures (around 5 mg) are introduced into 120 microliter stainless steel test cells which are pressure resistant (at least 150 bar), and are crimped shut using a crimping tool or a suitable press having a suitable seal (silver, graphite or nickel), ensuring the leaktightness of the device. The thermal stability of the mixtures was characterized using DSC by means of a calorimeter of the DSC111 Sensys type, sold by KEP-Setaram. The sample is subjected to a heating ramp between ambient temperature and 400 °C, at a rate of 5 °C/min. The heat flux exchanges are thus recorded as a function of temperature. Integration of the DSC signal makes it possible to access the overall energy of the thermal phenomena. The level of heat flux, and the shape of the peaks, makes it possible to evaluate the stabilizing or destabilizing character of the compounds.

Different samples comprising a polymer and ammonium nitrate were subjected to differential scanning calorimetry. The samples tested were prepared by mixing 5% polymer per 95% by weight of ammonium nitrate. Examples 1 and 2 were carried out with fluoropolymers according to the present invention. In example 1, the fluoropolymer used was a poly(vinylidene fluoride) homopolymer. In example 2, the fluoropolymer used was a copolymer of vinylidene fluoride and hexafluoropropylene (between 20 and 25% by weight of hexafluoropropylene). Comparative example 3 was carried out in the presence of polyvinyl butyral. The ammonium nitrate and the polyvinyl butyral were sieved to 400 microns. The reference example contained 100% ammonium nitrate. Example 4 contained a polyamide-polyether block copolymer (PEBAX® ES 1745).

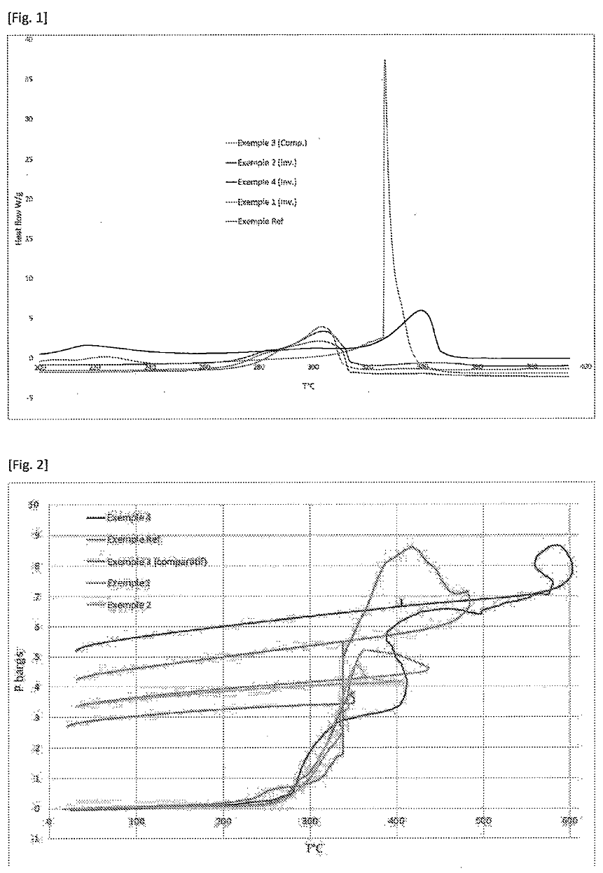

As can be seen in FIG. 1, the profile of the peaks obtained is very different between the examples carried out according to the present invention compared to the comparative example. The shape of the peaks is indicative of the potential speed of reaction of the ammonium nitrate under the effect of heat. In the presence of the fluoropolymers according to the present invention (examples 1, 2 and 4), the ammonium nitrate is greatly stabilized compared to a composition in which the ammonium nitrate is mixed with polyvinyl butyral (example 3).

The change in pressure as a function of time was also evaluated for these compositions. The sample is subjected to a heating ramp of 2-4 °C/min in an open glass cell within a closed, pressure-resistant chamber. The temperature in the sample and in the confinement chamber, and also the pressure in said chamber, are measured over time. The results are presented in FIG. 2. The profile obtained for examples 1, 2 and 4 demonstrates that the fluoropolymers A1 and the polymers A3 make it possible to stabilize the ammonium nitrate, since the rise in pressure is smaller than for the polyvinyl butyral (example 3). For a given temperature, the increase in pressure is less for the polymers according to the present invention. In addition, as can be seen in FIG. 2, the polymer according to example 4 (polyamide-polyether block copolymer) has a greater capacity to generate a blast effect. This is beneficial in applications such as airbags. This is because a greater blast effect enables the airbag to be inflated more rapidly.

1-21. (canceled)

22. A composition in powder form, comprising a polymer A and a compound B comprising at least one functional group selected from the group consisting of —NO₂, NO₃⁻—ON═O, —N═N—, —N⁻═N⁺N⁻—, NX₃, where X is a halogen, —C═N—O—, ClO₃⁻, ClO₄⁻, —O—O—, —O₃— and —C≡C⁻Mt⁺, where Mt is a transition metal, characterized in that:
said polymer A is a fluoropolymer A1, a polyamide A2 or a polyamide-polyether block copolymer A3 or a mixture thereof, and
said compound B has an oxygen balance OB of less than 60, said oxygen balance being determined by the formula OB (%)=[1600*(d−2a-(b/2)]/M, where a, b and d are the number of atoms of carbon, hydrogen and oxygen, respectively, in the compound B, and M is the molar mass of said compound B.

23. The composition as claimed in claim 22, characterized in that said polymer A is a polyamide A2 or a polyamide-polyether block copolymer A3 or a mixture thereof.

24. The composition as claimed in claim 22, characterized in that said compound B has a molar mass of less than 1000 g·mol⁻¹.

25. The composition as claimed in claim 22, characterized in that said compound B is selected from the group consisting of a salt of formula M⁺X⁻, where M is selected from the group consisting of Li, Na, K and NH₄; and X is selected from the group consisting of a nitrate anion, a chlorate anion and a perchlorate anion.

26. The composition as claimed in claim 22, characterized in that the composition also comprises poly(vinyl butyral).

27. The composition as claimed in claim 22, characterized in that said polymer A is said fluoropolymer A1 comprises monomer units derived from vinylidene fluoride and optionally monomer units of a monomer selected from the group consisting of vinyl fluoride; trifluoroethylene; (VF₃); chlorotrifluoroethylene (CTFE); 1,2-difluoroethylene; tetrafluoroethylene (TFE); hexafluoropropylene (HFP); perfluoro(alkyl vinyl) ethers; perfluoro(1,3-dioxole); perfluoro(2,2-dimethyl-1,3-dioxole) (PDD); the product of formula CF₂═CFOCF₂CF(CF₃)OCF₂CF₂X, where X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂, where n is 1, 2, 3, 4 or 5; the product of formula R¹CH₂OCF═CF₂, where R¹ is hydrogen or F(CF₂)m and m is 1, 2, 3 or 4; the product of formula R²OCF═CH₂, where R² is F(CF₂)p and p is 1, 2, 3 or 4; perfluorobutylethylene (PFBE); 3,3,3-trifluoropropene and 2-trifluoromethyl-3,3,3-trifluoro-1-propene, or a mixture thereof.

28. The composition as claimed in claim 27, characterized in that said fluoropolymer A1 is selected from a vinylidene fluoride homopolymer or a copolymer comprising monomer units derived from vinylidene fluoride and monomer units derived from a monomer selected from the group consisting of trifluoroethylene, chlorotrifluoroethylene, 1,2-difluoroethylene, tetrafluoroethylene, hexafluoropropylene, or a mixture thereof.

29. The composition as claimed in claim 28, characterized in that said fluoropolymer A1 comprises at least 50 mol % of monomer units derived from vinylidene fluoride.

30. The composition as claimed in claim 22, characterized in that said polymer A3 is a polyamide-polyether block copolymer is a copolymer having amide units (Ba1) and polyether units (Ba2), said amide unit (Ba1) corresponding to an aliphatic repeating unit selected from a unit obtained from at least one amino acid, a unit obtained from at least one lactam, or a unit obtained from the polycondensation:
of at least one diamine, and
of at least one dicarboxylic acid, said diamine and said diacid comprising from 4 to 36 carbon atoms.

31. The composition as claimed in claim 22, characterized in that the content by mass of polymer A in said composition is from 0.1 to 35%, based on the total weight of the composition.

32. The composition as claimed in claim 22, characterized in that the content by mass of said compound B in said composition is greater than 65% based on the total weight of the composition.

33. The composition as claimed in claim 22, characterized in that the content by mass of said compound B in said composition is greater than 65% based on the total weight of the composition; and said polymer A is a polyamide A2 or a polyamide-polyether block copolymer A3, or a mixture thereof.

34. The composition as claimed in claim 22, characterized in that the content by mass of said compound B in said composition is at least 80% based on the total weight of the composition; and said polymer A is a fluoropolymer A1.

35. The composition as claimed in claim 22, characterized in that it comprises said polymer A and said compound B and optionally poly(vinyl butyral).

36. The use of a polymer A as a stabilizer for an energy-containing composition, said polymer A being as defined in claim 22.

37. The use of a polymer A for desensitizing or sensitizing an energy-containing composition, said polymer A being as defined in claim 22, and said composition comprising a compound B having heat-release properties or volume-expansion properties.

38. The use as claimed in claim 36, characterized in that the content by mass of polymer A in said composition is from 0.1 to 35%.

39. The use as claimed in claim 38, characterized in that the content by mass of said compound B in said composition is greater than 65% based on the total weight of the composition; and said polymer A is a polyamide A2 or a polyamide-polyether block copolymer A3, or a mixture thereof, or the content by mass of said compound B in said composition is at least 80% based on the total weight of the composition; and said polymer A is a fluoropolymer A1.

40. A method for decreasing or increasing the intensity of response to heat of an energy-containing composition, said method comprising adding a polymer A as defined in claim 22 to said composition, the latter comprising a compound B having heat-release properties or volume-expansion properties.

41. The method as claimed in claim 40, characterized in that the content by mass of polymer A in said composition is from 0.1 to 35%, based on the total weight of the composition.

42. The method as claimed in claim 41, characterized in that the content by mass of said compound B in said composition is greater than 65% based on the total weight of the composition; and said polymer A is a polyamide A2 or a polyamide-polyether block copolymer A3, or a mixture thereof, or the content by mass of said compound B in said composition is at least 80% based on the total weight of the composition; and said polymer A is a fluoropolymer A1.
